(19) United States
(12) Patent Application Publication
(10) Pub. No.: US 2022/0198478 A1
(43) Pub. Date: Jun. 23, 2022

(54) PRODUCT EVALUATION APPARATUS AND PRODUCT EVALUATION METHOD

(71) Applicant: TOYOTA JIDOSHA KABUSHIKI KAISHA, Toyota-shi (JP)

(72) Inventor: Yuichiro NAKANO, Toyota-shi (JP)

(73) Assignee: TOYOTA JIDOSHA KABUSHIKI KAISHA, Toyota-shi (JP)

(21) Appl. No.: 17/556,641

(22) Filed: Dec. 20, 2021

(30) Foreign Application Priority Data
Dec. 23, 2020 (JP) 2020-214288

(51) Int. Cl. G06Q 30/02

(52) U.S. Cl. CPC G06Q 30/0201

(57) ABSTRACT

A product evaluation apparatus includes a controller configured to: acquire evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operations performed by the user on the product, the history of operations being categorized by a plurality of history items; and identify, among the plurality of specification items, one or more specification items that correspond to each evaluation item, based on the evaluation information, the specification information, and the history information.

### CROSS-REFERENCE TO RELATED APPLICATION

This application claims priority to Japanese Patent Application No. 2020-214288, filed on Dec. 23, 2020, the entire contents of which are incorporated herein by reference.

### TECHNICAL FIELD

The present disclosure relates to a product evaluation apparatus and a product evaluation method.

### BACKGROUND

Patent Literature (PTL) 1 describes technology for evaluating a product based on multiple pieces of collected data.

### CITATION LIST

### Patent Literature

PTL 1: JP 2006-039836 A

### SUMMARY

It is required to identify a specification that leads to an evaluation result of a product.

It would be helpful to identify a specification that leads to an evaluation result of a product.

A product evaluation apparatus according to the present disclosure includes a controller configured to:

acquire evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operations performed by the user on the product, the history of operations being categorized by a plurality of history items; and

identify, among the plurality of specification items, one or more specification items that correspond to each evaluation item, based on the evaluation information, the specification information, and the history information.

A product evaluation method according to the present disclosure includes:

acquiring, by a product evaluation apparatus, evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operations performed by the user on the product, the history of operations being categorized by a plurality of history items; and

identifying, by the product evaluation apparatus, one or more specification items that correspond to each evaluation item, among the plurality of specification items, based on the evaluation information, the specification information, and the history information.

According to the present disclosure, it is possible to identify a specification that leads to an evaluation result of a product.

### BRIEF DESCRIPTION OF THE DRAWINGS

In the accompanying drawings:

FIG. 1 is a block diagram illustrating a configuration of a product evaluation apparatus according to an embodiment of the present disclosure;

FIG. 2 is a flowchart illustrating operations of the product evaluation apparatus according to the embodiment of the present disclosure;

FIG. 3 is a flowchart of an evaluation score calculation process according to the embodiment of the present disclosure;

FIG. 4 is a flowchart of a correlation ratio calculation process according to the embodiment of the present disclosure;

FIG. 5 is a flowchart of an evaluation process according to the embodiment of the present disclosure;

FIG. 6 illustrates tables of evaluation results as to key buying factors and post-purchase evaluation according to the embodiment of the present disclosure;

FIG. 7 illustrates tables of evaluation results of a product performed by users on an evaluation item basis according to the embodiment of the present disclosure;

FIG. 8 is a table that illustrates evaluation scores calculated by averaging, per each evaluation item, evaluation results of the product performed by a plurality of users, according to the embodiment of the present disclosure;

FIG. 9 is a table that illustrates histories of operations performed by a plurality of users, histories of operations each being categorized by a plurality of history items per each user;

FIG. 10 is a table that illustrates correlation ratios of the respective history items calculated for each evaluation item;

FIG. 11 is a table that illustrates weighting factors for the respective history items determined on each specification item;

FIG. 12 is a table that illustrates results of aggregating weighted correlation ratios obtained per each combination of each evaluation item and each specification item; and

FIG. 13 is a table that illustrates specification items selected per each product.

### DETAILED DESCRIPTION

An embodiment of the present disclosure will be described below with reference to the drawings.

In the drawings, the same or corresponding portions are denoted by the same reference numerals. In the descriptions of the present embodiment, detailed descriptions of the same or corresponding portions are omitted or simplified, as appropriate.

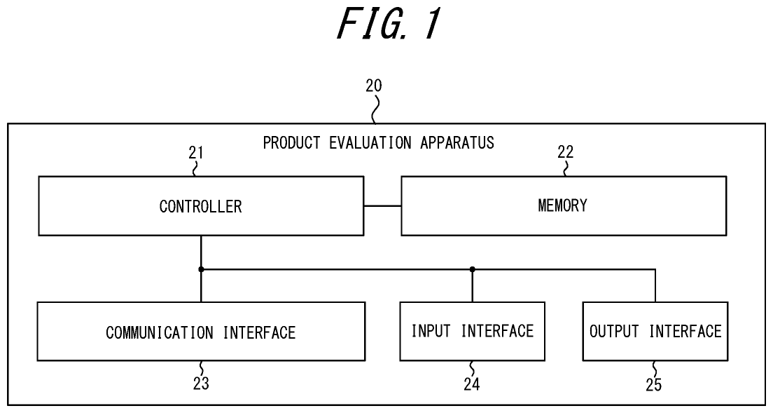

With reference to FIG. 1, a configuration of a product evaluation apparatus 20 according to the present embodiment will be described.

The product evaluation apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the product evaluation apparatus 20 while controlling each part of the product evaluation apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the product evaluation apparatus 20 and data obtained by the operations of the product evaluation apparatus 20.

The communication interface 23 includes at least one interface for communication. The interface for communication is, for example, a LAN interface. The communication interface 23 receives data to be used for the operations of the product evaluation apparatus 20, and transmits data obtained by the operations of the product evaluation apparatus 20.

The input interface 24 includes at least one interface for input. The interface for input is, for example, a physical key, a capacitive key, a pointing device, a touch screen integrally provided with a display, or a microphone. The input interface 24 accepts an operation for inputting data to be used for the operations of the product evaluation apparatus 20. The input interface 24 may be connected to the product evaluation apparatus 20 as an external input device, instead of being included in the product evaluation apparatus 20. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the product evaluation apparatus 20. The output interface 25 may be connected to the product evaluation apparatus 20 as an external output device, instead of being included in the product evaluation apparatus 20. As the connection method, any technology such as USB, HDMI®, or Bluetooth® can be used.

The functions of the product evaluation apparatus 20 are realized by executing a product evaluating program according to the present embodiment by a processor as the controller 21. That is, the functions of the product evaluation apparatus 20 are realized by software. The product evaluating program causes a computer to execute the operations of the product evaluation apparatus 20, thereby causing the computer to function as the product evaluation apparatus 20. That is, the computer executes the operations of the product evaluation apparatus 20 in accordance with the product evaluating program to thereby function as the product evaluation apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the product evaluation apparatus 20 may be realized by a programmable circuit or a dedicated circuit serving as the controller 21. That is, some or all of the functions of the product evaluation apparatus 20 may be realized by hardware.

An outline of the present embodiment will be described.

The product evaluation apparatus 20 according to the present embodiment acquires evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operations performed by the user on the product, the a history of operations being categorized by a plurality of history items. The product evaluation apparatus 20 identifies, among the plurality of specification items, one or more specification items that correspond to each evaluation item, based on the evaluation information, the specification information, and the history information.

The present embodiment enables to identify a specification that leads to an evaluation result of the product.

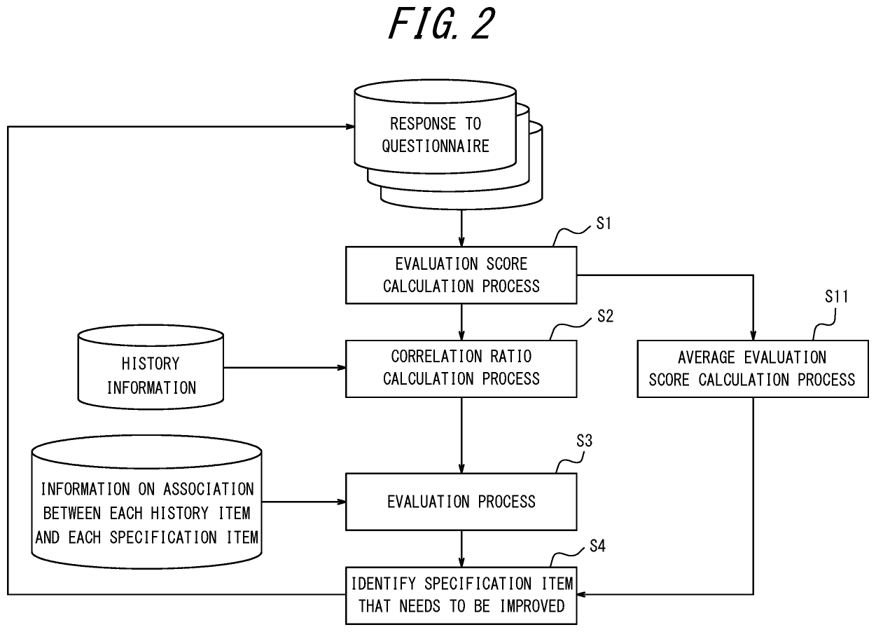

With reference to FIG. 2, operations of the product evaluation apparatus 20 according to the present embodiment will be described. These operations correspond to a product evaluation method according to the present embodiment.

In step S1 of FIG. 2, the controller 21 of the product evaluation apparatus 20 acquires evaluation information that indicates a result of an evaluation performed by a user for each evaluation item in a plurality of evaluation items for a product operated by the user. In the present embodiment, “evaluation information” is information that indicates a result of an evaluation performed by a user for each evaluation item in a plurality of evaluation items, for a product operated by the user. Any method may be used to acquire the evaluation information. The present embodiment employs a method that includes sending a questionnaire to a terminal apparatus of the user, and receiving, as the evaluation information, an input made by the user in response to the questionnaire. The terminal apparatus of the user is, for example, a mobile device such as a mobile phone, a smartphone, or a tablet, or a PC. The term “PC” is an abbreviation of personal computer. The controller 21 acquires, as the evaluation information, a response to a questionnaire for a certain product P, obtained from each user in a plurality of users U1, U2, U3 . . . . The controller 21 calculates, based on the response to the questionnaire, evaluation scores representing results of evaluations. The controller 21 stores information that indicates the calculated evaluation scores in the memory 22 of the product evaluation apparatus 20.

The evaluation scores may be calculated by any method; in the present embodiment, the evaluation scores are calculated by the following method, which is similar to the method described in PTL 1.

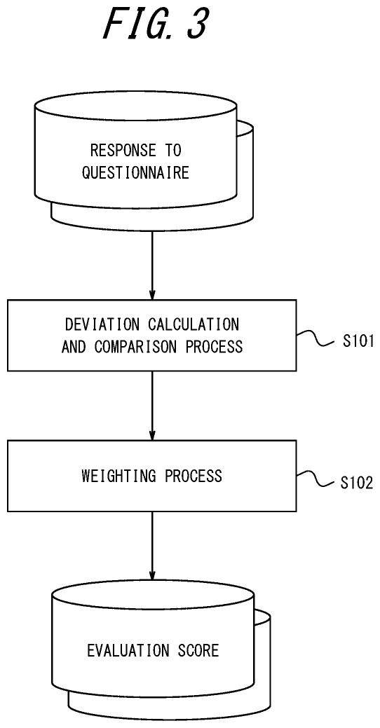

With reference to FIG. 3, an evaluation score calculation process according to the present embodiment will be described.

In step S101 of FIG. 3, the controller 21 of the product evaluation apparatus 20 performs a deviation calculation and comparison process on the response to the questionnaire obtained from each user in the plurality of users U1, U2, U3 . . . . In the present embodiment, the response to the questionnaire includes responses to a plurality of types of questionnaires. Specifically, the responses to the questionnaires include responses to two types of questionnaires, namely, a questionnaire as to “key buying factor” and a questionnaire as to “post-purchase evaluation”.

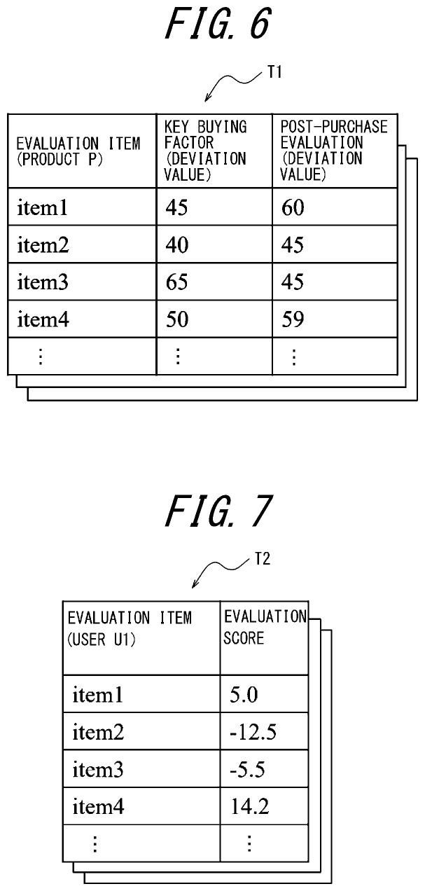

With reference to FIG. 6, a configuration example of a table that stores deviation values obtained for respective evaluation items for the product P from each user in the plurality of users U1, U2, U3 . . . will be described.

In table T1 of FIG. 6, the “key buying factor” indicates points on which each user placed importance in purchasing the product P. The “post-purchase evaluation” indicates evaluations made by each user for the respective evaluation items after each user has purchased the product P. The evaluations made by each user are acquired as evaluation grades. In table T1, for an evaluation item i1 identified by an evaluation item identifier “item1”, an evaluation grade for “key buying factor” is converted into a deviation value of “45”. For an evaluation item i2 identified by an evaluation item identifier “item2”, an evaluation grade for “key buying factor” is converted into a deviation value of “40”. For an evaluation item i3 identified by an evaluation item identifier “item3”, an evaluation grade for “key buying factor” is converted into a deviation value of “65”. For an evaluation item i4 identified by an evaluation item identifier “item4”, an evaluation grade for “key buying factor” is converted into a deviation value of “50”. Similarly, for the evaluation item i1 identified by the evaluation item identifier “item1”, an evaluation grade for “post-purchase evaluation” is converted into a deviation value of “60”. For the evaluation item i2 identified by the evaluation item identifier “item2”, an evaluation grade for “post-purchase evaluation” is converted into a deviation value of “45”. For the evaluation item i3 identified by the evaluation item identifier “item3”, an evaluation grade for “post-purchase evaluation” is converted into a deviation value of “45”. For the evaluation item i4 identified by the evaluation item identifier “item4”, an evaluation grade for “post-purchase evaluation” is converted into a deviation value of “59”.

In the present embodiment, the plurality of evaluation items include a feature, function, quality, or concept of the product P. In the present embodiment, the product P is a vehicle. The evaluation items include a concept keyword that indicates the concept of the vehicle as the product P. Alternatively, the evaluation items may include the feature, function, or quality of the product P. Examples of the concept keyword include braking performance, operability, ride quality, classy, sporty, and luxury.

In step S102 of FIG. 3, the controller 21 of the product evaluation apparatus 20 calculates evaluation scores for the respective evaluation items for each user in the plurality of users U1, U2, U3 . . . , based on a result of the deviation calculation and comparison process of step S101. Specifically, the controller 21 performs a weighting process per each evaluation item, based on the result of the deviation calculation and comparison process of step S101 performed on the response to the questionnaire obtained from each user in the plurality of users U1, U2, U3 . . . , to thereby calculate the evaluation scores for the respective evaluation items per each user. As an example, table T2 of FIG. 7 illustrates a result of calculating the evaluation scores for the respective evaluation items, for the user U1 among the plurality of users U1, U2, U3 . . . .

Table T2 of FIG. 7 illustrates, per each user, evaluation results for the respective evaluation items for the product P, as evaluation scores In table T2, the evaluation score of 5.0 is obtained from the user U1 for the evaluation item i1 identified by the evaluation item identifier “item1”. The evaluation score of −12.5 is obtained from the user U1 for the evaluation item i2 identified by the evaluation item identifier “item2”. The evaluation score of −5.5 is obtained from the user U1 for the evaluation item i3 identified by the evaluation item identifier “item3”. The evaluation score of 14.2 is obtained from the user U1 for the evaluation item i4 identified by the evaluation item identifier “item4”.

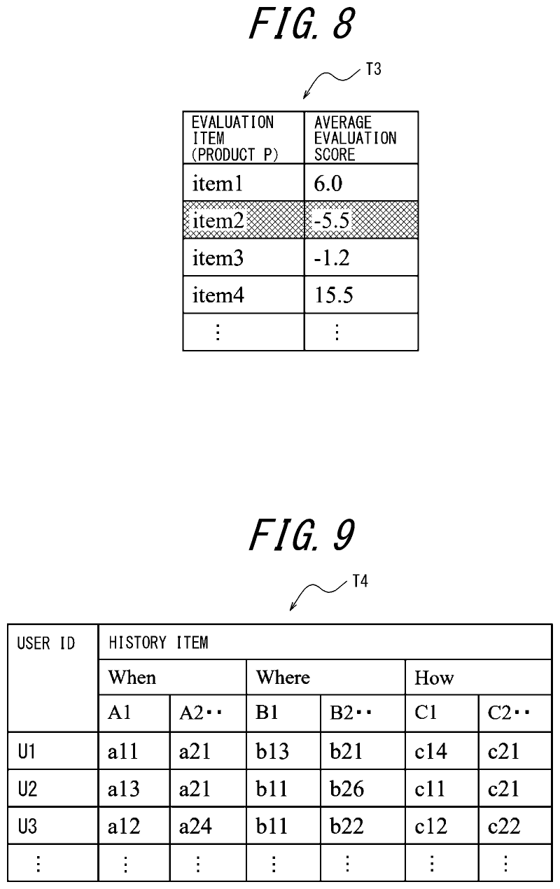

The controller 21 of the product evaluation apparatus 20 may further calculate, in step S11 of FIG. 2, an average value of the evaluation scores obtained from the respective plurality of users U1, U2, U3 . . . . As an example, table T3 of FIG. 8 illustrates, as average evaluation scores, average values of the evaluation scores from the plurality of users U1, U2, U3 . . . , the average values of the evaluation scores being calculated per each evaluation item of the product P.

In table T3 of FIG. 8, an average evaluation score of 6.0 is obtained for the evaluation item i1 identified by the evaluation item identifier “item1”, for the product P. An average evaluation score of −5.5 is obtained for the evaluation item i2 identified by the evaluation item identifier “item2”. An average evaluation score of −1.2 is obtained for the evaluation item i3 identified by the evaluation item identifier “item3”. An average evaluation score 15.5 is obtained for the evaluation item i4 identified by the evaluation item identifier “item4”.

In step S2 of FIG. 2, the controller 21 of the product evaluation apparatus 20 acquires history information that indicates a history of operations performed by the user on the product, the history of operations being categorized by a plurality of history items. The controller 21 calculates, based on the evaluation information and the history information, a correlation ratio of each history item for each evaluation item in the plurality of evaluation items.

The correlation ratio may be calculated by any method; the present embodiment employs the following method.

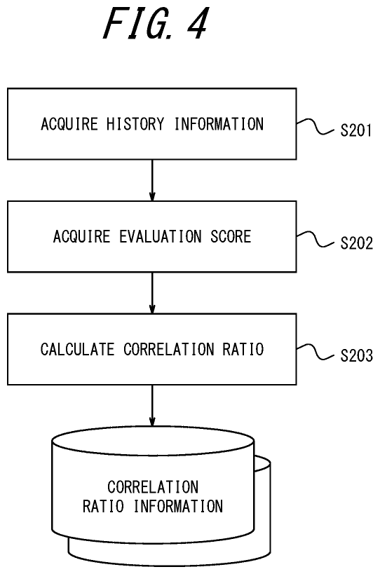

With reference to FIG. 4, a correlation ratio calculation process according to the present embodiment will be described.

In step S201 of FIG. 4, the controller 21 of the product evaluation apparatus 20 acquires history information. In the present embodiment, the “history information” is information that indicates a history of operations performed by a user on the product P, the history of operations being categorized by a plurality of history items. In the present embodiment, the controller 21 acquires history information for each user in the plurality of users U1, U2, U3 . . . . A history of operations made on the product P by each user in the plurality of users U1, U2, U3 . . . is recorded and accumulated by taking one trip as one unit. One trip means that a user travels from a first location to a second location by the product P.

In the present embodiment, the plurality of history items include a situation in which an operation is performed, a time period when the operation is performed, a site where the operation is performed, a purpose for which the operation is performed, or the type of the operation. An example of the situation in which the operation is performed includes weather. Examples of the time period when the operation is performed include morning, noon, or night. Examples of the site where the operation is performed include a region, a highway, a public road, an intersection, a pedestrian crossing, or a railroad crossing. Examples of the purpose for which the operation is performed include stopping, obstacle avoidance, or acceleration. Examples of the type of the operation include a steering wheel operation, a brake operation, or an accelerator operation. The history of the operations made on the product P by each user in the plurality of users U1, U2, U3 . . . may be categorized per each trip, or categorized collectively per a plurality of trips. That is, a history of operations made on the product P by each user who has purchased the product P may be categorized collectively over a certain period of time after the purchase of the product P. In a case in which the history of operations are categorized collectively per a plurality of trips, values for the plurality of trips categorized by each history item may be averaged.

The history information may be acquired by any method. In the present embodiment, data acquired by a recording apparatus or the like installed in a vehicle as the product P is acquired via the communication interface 23.

FIG. 9 illustrates, as table T4, a configuration example of a table that stores history information acquired for the product P.

Table T4 of FIG. 9 stores a plurality of records that indicates histories of operations performed on the product P by each user in the plurality of users U1, U2, U3 . . . . Each record includes a user identifier (ID) that identifies a user who performed the operations, and when, where, and how the operations have been performed by the user. In other words, the operations performed by each user are recorded as being categorized by time elements, site elements, and method means elements.

In table T4 of FIG. 9, a history item “A1” indicates weather, “A2” indicates a time period, “B1” indicates a region, “B2” indicates a road type, “C1” indicates a steering wheel operation, and “C2” indicates a brake operation. A record stored in the first row includes a user identifier “U1” that identifies the user U1 and operations performed by the user U1, the operations being categorized by “a11” as the weather, “a21” as the time period, “b13” as the region, “b21” as the road type, “c14” as the steering wheel operation, and “c21” as the brake operation. A record stored in the second row includes a user identifier “U2” that identifies the user U2, and operations performed by the user U2, the operations being categorized by “a13” as the weather, “a21” as the time period, “b11” as the region, “b26” as the road type, “c11” as the steering wheel operation, and “c21” as the brake operation. A record stored in a third row includes a user identifier “U3” that identifies the user U3 and operations performed by the user U3, the operations being categorized by “a12” as the weather, “a24” as the time period, “b11” as the region, “b22” as the road type, “c12” as the steering wheel operation, and “c22” as the brake operation.

In step S202 of FIG. 4, the controller 21 of the product evaluation apparatus 20 acquires information that indicates the evaluation scores calculated in step S1 of FIG. 2. The controller 21 reads the information that indicates the evaluation scores, from the memory 22.

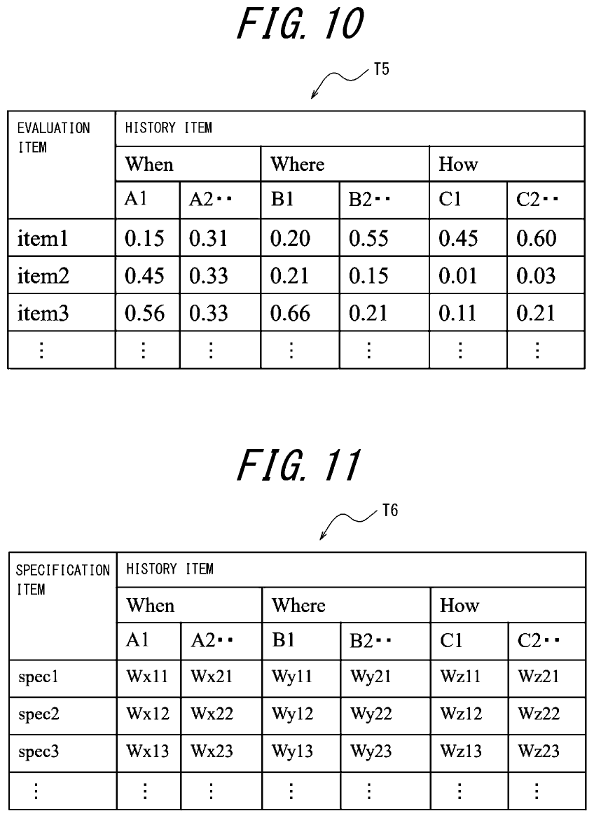

In step S203 of FIG. 4, the controller 21 of the product evaluation apparatus 20 refers to the evaluation information to calculate a correlation ratio of each history item A1, A2, . . . , with respect to each evaluation item in the plurality of evaluation items i1, i2, i3, . . . . The controller 21 stores the calculated correlation ratios in a table as illustrated in FIG. 10.

FIG. 10 illustrates, as table T5, a configuration example of a table that stores correlation ratios of the respective history items calculated for each evaluation item in the plurality of evaluation items.

Table T5 of FIG. 10 stores a plurality of records each indicating the correlation ratios of the respective history items calculated for each evaluation item in the plurality of evaluation items. Each record includes an evaluation item identifier that identifies an evaluation item and the correlation ratios of the respective historical items calculated for the evaluation item.

In table T5 of FIG. 10, a history item “A1” is weather, “A2” is a time period, “B1” is a region, “B2” is a road type, “C1” is a steering wheel operation, and “C2” is a brake operation. A record stored in the first row includes an evaluation item identifier “item1” that identifies the evaluation item i1, and, with respect to the evaluation item i1, a correlation ratio of “0.15” for weather, a correlation ratio of “0.31” for the time period, a correlation ratio of “0.20” for the region, a correlation ratio of “0.55” for the road type, a correlation ratio of “0.45” for the steering wheel operation, and a correlation ratio of “0.60” for the brake operation. A record stored in the second row includes an evaluation item identifier “item2” that identifies the evaluation item i2, and, with respect to the evaluation item i2, a correlation ratio of “0.45” for the weather, a correlation ratio of “0.33” for the time period, a correlation ratio of “0.21” for the region, a correlation ratio of “0.15” for the road type, a correlation ratio of “0.01” for the steering wheel operation, and a correlation ratio of “0.03” for the brake operation. A record stored in a third row includes an evaluation item identifier “item3” that identifies the evaluation item i3, and a correlation ratio of “0.56” for the weather, a correlation ratio of “0.33” for the time period, a correlation ratio of “0.66” for the region, a correlation ratio of “0.21” for the road type, a correlation ratio of “0.11” for the steering wheel operation, and a correlation ratio of “0.21” for the brake operation.

In step S3 of FIG. 2, the controller 21 of the product evaluation apparatus 20 acquires specification information that indicates a content of a specification determined for each specification item in a plurality of specification items for the product P. The controller 21 evaluates a degree of association of each specification item with respect to each evaluation item, based on the evaluation information, the specification information, and the history information.

The controller 21 of the product evaluation apparatus 20 weights, per each combination of each evaluation item and specification item, the correlation ratio for each history item with a weighting factor for each history item, per each combination of each evaluation item and each specification item, and aggregates the weighted correlation ratios obtained for the plurality of history items, to thereby evaluate degree of association.

In the present embodiment, the plurality of specification items includes dimensions, a weight, materials, or parts of the product P. Examples of the dimensions of the product P include a vehicle height and a vehicle width. An example of the weight of the product P includes a vehicle weight. Examples of the materials of the product P include a steel plate, aluminum, and carbon. Examples of the parts of the product P include a steering, brakes, and seat belts. For example, in a case in which the specification item is “vehicle height”, a specific value of the vehicle height falls under the “specification content”.

In the present embodiment, each specification item has weighting factors for the respective history items. FIG. 11 illustrates, as table T6, a configuration example of a table that stores the weighting factors for the respective history items for each specification item. In the present embodiment, the “weighting factor” indicates importance of each specification item relative to a certain history item.

Table T6 of FIG. 11 stores a plurality of records each indicating weighting factors of each specification item with respect to the respective history items. Each specification item in the plurality of specification items has the weighting factors for the respective history items. That is, each record includes a specification item identifier that identifies a specification item, and the weighting factors that are determined for a combination of the specification item and each history item.

In table T6 of FIG. 11, a history item “A1” represents weather, “A2” represents a time period, “B1” represents a region, “B2” represents a road type, “C1” represents a steering wheel operation, and “C2” represents a brake operation. A record stored in the first row includes the specification item identifier “spec1” that identifies the specification item s1, and, with respect to the specification item s1, a weighting factor of “Wx11” for the weather, a weighting factor of “Wx21” for the time period, a weighting factor of “Wy11” for the region, a weighting factor of “Wy21” for the road type, a weighting factor of “Wz11” for the steering wheel operation, and a weighting factor of “Wz21” for the brake operation. A record stored in the second row includes the specification item identifier “spec2” that identifies the specification item s2, and, with respect to the specification item s2, a weighting factor of “Wx12” for the weather, a weighting factor of “Wx22” for the time period, a weighting factor of “Wy12” for the region, a weighting factor of “Wy22” for the road type, a weighting factor of “Wz12” for the steering wheel operation, and a weighting factor of “Wz22” for the brake operation. A record stored in the third row includes the specification item identifier “spec3” that identifies the specification item s3, and, with respect to the specification item s3, a weighting factor of “Wx13” for the weather, a weighting factor of “Wx23” for the time period, a weighting factor of “Wy13” for the region, a weighting factor of “Wy23” for the road type, a weighting factor of “Wz13” for the steering wheel operation, and a weighting factor of “Wz23” for the brake operation.

Any method may be used to evaluate the degree of association; the present embodiment employs the following method.

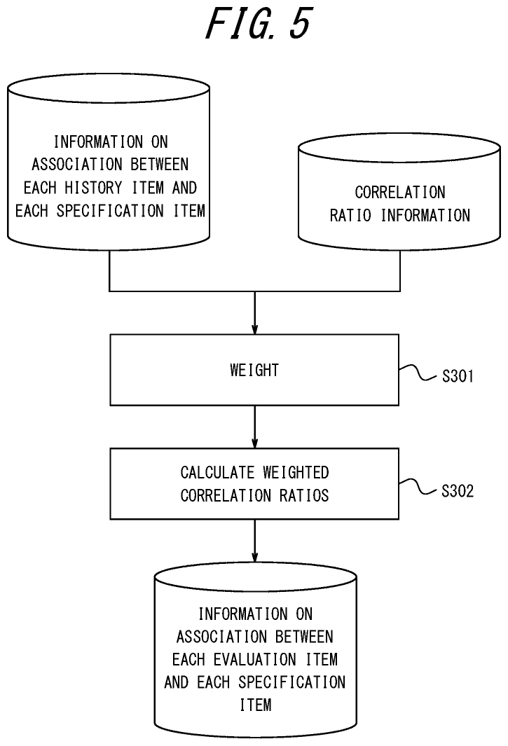

With reference to FIG. 5, a flow of an evaluation process in step S3 of FIG. 2 will be described.

In step S301 of FIG. 5, the controller 21 of the product evaluation apparatus 20 weights, per each combination of each evaluation item and each specification item, the correlation ratios of the respective history items with the weighting factors for the respective history items. Specifically, the controller 21 refers to table T6 illustrated in FIG. 11, as association information between each history item and each specification item. The controller 21 refers to table T5 illustrated in FIG. 10 as correlation ratio information. The controller 21 weights 0.15, which is a correlation ratio for the history item A1 with respect to the evaluation item i1 illustrated in table T5, by Wx11, which is a weighting factor for the specification item s1 with respect to the history item A1 illustrated in table T6, to obtain a weighted correlation ratio. Similarly, the controller 21 weights 0.31, which is a correlation ratio of the history item A2 with respect to the evaluation item i1, by Wx21, which is a weighting factor of the specification item s1 for the history item A2, to obtain a weighted correlation ratio. Similarly, for the combination of the evaluation item i1 and the specification item s2, the controller 21 weights 0.15, which is the correlation ratio of the history item A1 with respect to the evaluation item i1, by Wx12, which is a weighting factor of the specification item s2 with respect to the history item A1, to obtain a weighted correlation ratio. Similarly, the controller 21 weights 0.31, which is the correlation ratio of the history item A2 with respect to the evaluation item i1, by Wx22, which is a weighting factor of the specification item s2 with respect to the history item A2, to obtain a weighted correlation ratio.

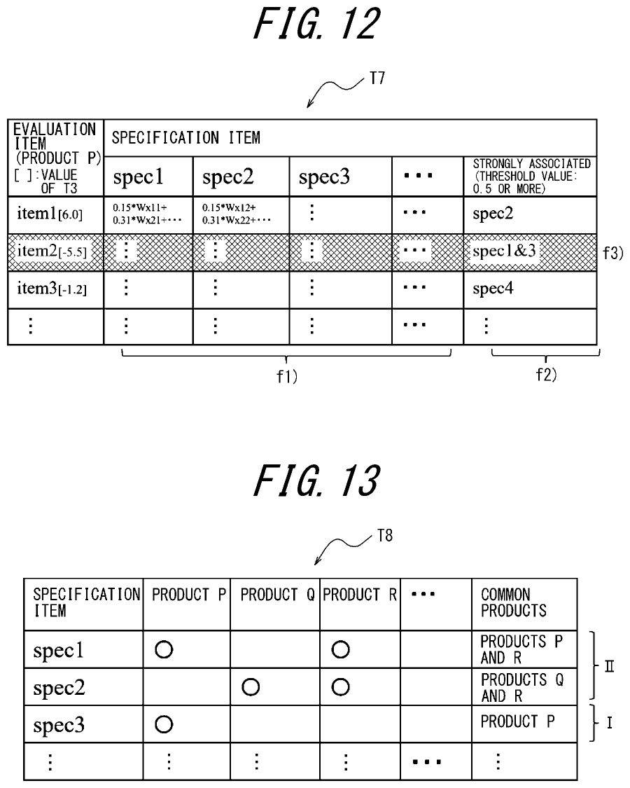

In step S302 of FIG. 5, the controller 21 of the product evaluation apparatus 20 aggregates the weighted correlation ratios obtained for the plurality of history items. Specifically, the controller 21 sequentially adds up the weighted correlation ratios obtained per each history item in step S301. In this way, the weighted correlation ratios obtained for the respective history items are aggregated. The controller 21 stores a result of aggregating the weighted correlation ratios per each combination of each evaluation item and each specification item, in each cell of f1) in table T7 illustrated in FIG. 12.

FIG. 12 illustrates, as table T7, a configuration example of a table that stores results of aggregating the weighted correlation ratios, which are obtained by weighting the respective correlation ratios illustrated in table T5 of FIG. 10 with the respective weighting factors illustrated in table T6 of FIG. 11. Table T7 of FIG. 12 stores, per each combination of each evaluation item and each specification item, results of weighting the correlation ratios of the respective history items with the weighting factors for the respective history items and aggregating the weighted correlation ratios obtained for the plurality of history items.

The controller 21 of the product evaluation apparatus 20 identifies one or more specification items that correspond to each evaluation item, among the plurality of specification items, based on the evaluation information, the specification information, and the history information. In other words, the controller 21 identifies one or more specification items that correspond to each of the evaluation items, with reference to results of evaluating the degrees of association. Specifically, the controller 21 compares, per each specification item, the degrees of association for each evaluation item in the evaluation items with an evaluation threshold value, and identifies a specification item whose degree of association for one or more evaluation items in the plurality of evaluation items is higher than the evaluation threshold value, as a specification item corresponding to the one or more evaluation items. For example, the controller 21 refers to table T7 illustrated in FIG. 12, as results of evaluating the degrees of association. In the present embodiment, the controller 21 compares each aggregate value per each combination of each evaluation item and each specification item illustrated in table T7, with the evaluation threshold value, and identifies a specification item whose aggregate value is higher than the evaluation threshold value. In the present embodiment, the evaluation threshold value is set to 0.5. The controller 21 identifies, for each evaluation item, a specification item having an aggregate value of 0.5 or more, as the specification item that corresponds to the evaluation item. In table T7 of FIG. 12, identifiers of specification items that are identified for the respective evaluation items are displayed in a rightmost column f2). In table T7, the specification item s2 is identified as a specification item that corresponds to the evaluation item i1. The specification items s1 and s3 are identified as specification items that correspond to the evaluation item i2. The specification item s4 is identified as a specification item that corresponds to the evaluation item i3.

As described above, the controller 21 of the product evaluation apparatus 20 acquires evaluation information that indicates a result of evaluations performed by a user for each evaluation item in a plurality of evaluation items for a product P operated by the user, specification information that indicates a content of a specifications determined for each specification item in the plurality of specification items for the product P, and history information that indicates a history of operations performed by the user on the product P, the history of operations being categorized by a plurality of history items. The controller 21 identifies, among the plurality of specification items, one or more specification items that correspond to each evaluation item, based on the acquired evaluation information, specification information, and history information.

The present embodiment enables to identify a specification that leads to an evaluation result of the product P.

In step S4 of FIG. 2, the controller 21 of the product evaluation apparatus 20 may further identify a specification item that needs to be improved. Specifically, the controller 21 compares the degrees of association evaluated for the respective specification items in the plurality of specification items, for an evaluation item whose evaluation score is less than a score threshold value, among the plurality of evaluation items. The controller 21 selects one or more specification items according to a result of the comparison. The controller 21 generates improvement information that proposes improvement in the selected specification items.

In the present embodiment, the controller 21 of the product evaluation apparatus 20 refers to table T3 of FIG. 8. In table T3 of FIG. 8, suppose that a score threshold value is −3. The controller 21 determines that, among evaluation results for the plurality of evaluation items, the evaluation item i2 whose average evaluation score is −5.5 has an evaluation result that is less than the score threshold value. The controller 21 selects, for the evaluation item i2, one or more specification items whose aggregate values are 0.5 or more. Specifically, as illustrated in table T7 of FIG. 12, the specification items s1 and s3 identified by the specification item identifiers of “spec1” and “spec3”, respectively, are selected. The controller 21 of the product evaluation apparatus 20 generates improvement information that proposes improvement in the specification items s1 and s3.

The controller 21 of the product evaluation apparatus 20 may further determine a relative ratio of involvement with respect to the evaluation item i2, between the specification items s1 and s3 which are identified as specification items corresponding to the evaluation item i2 in step S3 of FIG. 2. Specifically, the controller 21 determines the relative ratio of involvement with respect to the evaluation item i2 between the specification items s1 and s3, based on the aggregate values of the specification items s1 and s3, which are identified as specification items corresponding to the evaluation item i2. As an example, suppose that the specification items s1 and s3, which are identified as specification items corresponding to the evaluation item i2, each have the aggregate values of 3.2 and 0.8, respectively. The controller 21 calculates the relative ratio between the aggregate values for the respective specification items. Specifically, the controller 21 calculates the relative ratio of involvement with respect to the evaluation item i2 between the specification items s1 and s3 as 3.2:0.8=80%:20%. The controller 21 may further select any of the specification items according to a result of determining the ratio of involvement. As an example, the controller 21 selects the specification items in decreasing order of the ratio of involvement. This enables to propose improvement in the specification items in decreasing order of the need for improvement, among the specification items that are identified as causes that lead to an evaluation result for the product.

As a variation of the present embodiment, the product to be evaluated may include a plurality of products P, Q, and R. The controller 21 of the product evaluation apparatus 20 may perform the processes from step S1 to step S4 for each product in the plurality of products P, Q, and R. The controller 21 may categorize, depending on the number of products for which one specification item is selected in common, the specification items into those that are capable of being addressed by a plurality of products in common and those that need to be addressed by each individual product. FIG. 13 illustrates table T8, as an example of a table that illustrates specification items selected for each product in the plurality of products P, Q, and R. In table T8, a specification item s1 is selected for the products P and R. A specification item s2 is selected for the products Q and R. A specification item s3 is selected for the product P. Accordingly, the controller 21 categorizes the specification items s1 and s2 indicated with “II” in table T8, as specification items that are capable of being addressed by a plurality of products in common. On the other hand, the controller 21 categorizes the specification item s3 indicated with “I” in table T8, as a specification item that needs to be addressed by each individual product. This variation enables to output the specification items that are capable of being addressed by a plurality of products in common, as information on candidate components that may be commonly designed.

As a variation of the present embodiment, the controller 21 of the product evaluation apparatus 20 may display a result of evaluating the degree of association on the output interface 25. For example, the controller 21 may display table T7 illustrated in FIG. 12 on a display as the output interface 25 of the product evaluation apparatus 20.

As a variation of the present embodiment, the controller 21 of the product evaluation apparatus 20 may transmit, via the communication interface 23, information that indicates a result of evaluating the degree of association to a terminal apparatus such as a PC of an administrator.

As a variation of the present embodiment, the processes of step S1 to step S4 of FIG. 2 may be repeated. This variation enables to re-evaluate a product after the improvement. The processes according to the present disclosure may be continuously performed for a purchaser of the product after the improvement, so that a product that keep up with the latest needs can be provided. Further, evaluations equivalent to the above evaluations are performed while being compared time series, which enables to quantitatively measure transition in preferences of product purchasers. In addition, when the data is accumulated, a mathematical model can be created to estimate product specifications for obtaining desired scores.

The present disclosure is not limited to the embodiment described above. For example, a plurality of blocks described in the block diagram may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

The product P, which is illustrated as a vehicle in the above-described embodiments, may be any product that is operated by a user and evaluated by the user based on the result of operation. For example, the product P may be a household appliance such as a refrigerator or a washing machine.

1. A product evaluation apparatus comprising a controller configured to:
acquire evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operations performed by the user on the product, the history of operations being categorized by a plurality of history items; and
identify, among the plurality of specification items, one or more specification items that correspond to each evaluation item, based on the evaluation information, the specification information, and the history information.

2. The product evaluation apparatus according to claim 1, wherein the controller is configured to:
evaluate a degree of association of each specification item with respect to each evaluation item in the plurality of evaluation items, based on the evaluation information, the specification information, and the history information; and
identify one or more specification items that correspond to each evaluation item with reference to a result of the evaluation of the degree of association.

3. The product evaluation apparatus according to claim 2, wherein the controller is configured to:
compare, per each specification item, the degree of association for each evaluation item in the plurality of evaluation items with an evaluation threshold value; and
identify a specification item whose degree of association with respect to one or more evaluation items, among the plurality of evaluation items, is higher than the evaluation threshold value, as a specification item that corresponds to the one or more evaluation items.

4. The product evaluation apparatus according to claim 2, wherein the controller is configured to:
calculate a correlation ratio of each history item with respect to each evaluation item in the plurality of evaluation items, based on the evaluation information and the history information; and
evaluate the degree of association using the calculated correlation ratio.

5. The product evaluation apparatus according to claim 4, wherein
a weighting factor for each history item is determined on each specification item in the plurality of specification items, and
the controller is configured to, per each combination of each evaluation item and each specification item, weight the correlation ratio of each history item with a weighting factor for each history item, and aggregate the weighted correlation ratios obtained for the plurality of history items, to thereby evaluate the degree of association.

6. The product evaluation apparatus according to claim 2, wherein
a result of the evaluation is represented by an evaluation score, and
the controller is configured to:
with respect to an evaluation item whose evaluation score is less than a score threshold value, among the plurality of evaluation items, compare the degrees of association evaluated for the respective specification items in the plurality of specification items;
select any of the specification items according to a result of the comparison; and
generate improvement information that proposes an improvement in the selected specification item.

7. The product evaluation apparatus according to claim 2, further comprising an output interface,
wherein the controller is configured to display a result of the evaluation of the degree of association on the output interface.

8. The product evaluation apparatus according to claim 2, further comprising a communication interface,
wherein the controller is configured to transmit, via the communication interface, information that indicates a result of the evaluation of the degree of association to a terminal apparatus of an administrator.

9. The product evaluation apparatus according to claim 1, wherein the plurality of history items includes a situation in which the operation is performed, a time period when the operation is performed, a site where the operation is performed, a purpose for which the operation is performed, or a type of the operation.

10. The product evaluation apparatus according to claim 1, wherein the plurality of evaluation items includes a feature, function, quality, or concept of the product.

11. The product evaluation apparatus according to claim 1, wherein the plurality of specification items includes a dimension, weight, material, or component of the product.

12. The product evaluation apparatus according to claim 1, wherein the product is a vehicle.

13. The product evaluation apparatus according to claim 1, wherein the controller is configured to acquire, as the evaluation information, information that indicates results of evaluations performed by a plurality of users.

14. The product evaluation apparatus according to claim 1, wherein the controller is configured to acquire, as the history information, information that indicates histories of operations performed by a plurality of users.

15. A product evaluation method comprising:
acquiring, by a product evaluation apparatus, evaluation information that indicates a result of an evaluation performed by a user for each evaluation item in a plurality of evaluation items for a product operated by the user, specification information that indicates a content of a specification determined for each specification item in a plurality of specification items for the product, and history information that indicates a history of operation s performed by the user on the product, the history of operations being categorized by a plurality of history items; and
identifying, by the product evaluation apparatus, one or more specification items that correspond to each evaluation item, among the plurality of specification items, based on the evaluation information, the specification information, and the history information.

16. The product evaluation method according to claim 15, wherein the identifying includes:
evaluating a degree of association of each specification item with respect to each evaluation item in the plurality of evaluation items, based on the evaluation information, the specification information, and the history information; and
identifying one or more specification items that correspond to each evaluation item with reference to an evaluation result.

17. The product evaluation method according to claim 16, wherein the evaluating of the degree of association includes:
comparing the degree of association of each specification item with respect to each evaluation item, with an evaluation threshold value; and
identifying a specification item whose degree of association with respect to one or more evaluation items, among the plurality of evaluation items, is higher than the evaluation threshold value, as a specification item that corresponds to the one or more evaluation items.

18. The product evaluation method according to claim 16, wherein the evaluating of the degree of association includes:
calculating a correlation ratio of each history item with respect to each evaluation item in the plurality of evaluation items, based on the evaluation information and the history information; and
evaluating the degree of association using the calculated correlation ratio.

19. The product evaluation method according to claim 18, wherein
a weighting factor for each history item is determined on each specification item in the plurality of specification items, and
the evaluating of the degree of association includes:
per each combination of each evaluation item and each specification item, weighting the correlation ratio of each history item with a weighting factor for each history item; and
aggregating the weighted correlation ratios obtained for the plurality of history items, to thereby evaluate the degree of association.

20. The product evaluation method according to claim 17, wherein
a result of the evaluation is represented by an evaluation score, and
the product evaluation method further comprises:
with respect to an evaluation item whose evaluation score is less than a score threshold value, among the plurality of evaluation items, comparing, by the product evaluation apparatus, the degrees of association evaluated for the respective specification items in the plurality of specification items;
selecting, by the product evaluation apparatus, any of the specification items according to a result of the comparison; and
generating, by the product evaluation apparatus, improvement information that proposes an improvement in the selected specification item.
